(19) United States
(12) Patent Application Publication
(10) Pub. No.: US 2026/0145759 A1
(43) Pub. Date: May 28, 2026

(54) NOVEL MANNED FOLDING ELECTRIC CART

(71) Applicant: SHENZHEN YUNRUI IOT TECHNOLOGY CO., LTD., Shenzhen (CN)

(72) Inventors: Haicheng LUO, Dongguan (CN); Xiuqing LI, Xiangyang (CN)

(21) Appl. No.: 19/451,341

(22) Filed: Jan. 16, 2026

Related U.S. Application Data
(63) Continuation-in-part of application No. PCT/CN2024/105636, filed on Jul. 16, 2024.

(30) Foreign Application Priority Data
Jul. 17, 2023 (CN) 202321879711.1

(51) Int. Cl. B62K 15/00; B62K 21/16

(52) U.S. Cl. CPC B62K 15/006; B62K 21/16; B62K 2204/00

(57) ABSTRACT

A novel manned folding electric cart, comprising: a folding cart body. A seat apparatus is arranged on a top portion of a front end of the folding cart body, a steering rod assembly is connected to a bottom portion of the front end of the folding cart body, and at least one first wheel is connected to the steering rod assembly. An end of the folding cart body away from the steering rod assembly is provided with at least two second wheels. implement a seating function and to enable use of the electric cart to be more labor-saving. In addition, the steering rod assembly so that the steering rod assembly can extend out, to increase the distance between a support stress point of the seat apparatus and a support point of the first wheel, so that the stability of manned driving is improved and safety performance is improved.

### CROSS-REFERENCE TO RELATED APPLICATIONS

This application is a Bypass Continuation Application of PCT International Application No. PCT/CN2024/105636 filed on Jul. 16, 2024, which claims the priority of Chinese Application No. 202321879711.1, filed on Jul. 17, 2023, the disclosures of which are incorporated in their entirety by reference herein.

### TECHNICAL FIELD

The present disclosure relates to the technical field of folding carts, and in particular to a novel manned folding electric cart.

### BACKGROUND

Folding carts refer to a type of foldable and towable cargo cart, and are widely used for carrying and transporting goods due to their ease of use, ability to carry goods, ease of storage, and time-saving and labor-saving properties. Folding wagons are now commonly used for outdoor activities or short-distance transportation.

Conventional carts are manually towed during use, which is time-consuming and labor-intensive, and becomes particularly inconvenient when carrying loads uphill. To address the problem, the prior art further designs a power-assisted cart, as disclosed in Chinese Patent No. CN202220922980.0 titled “Power-Assisted Cart”, which provides electric power-assist during towing through electric wheels and a control device on the cart body, thereby making the cart more labor-saving and convenient during use. However, this solution still has some drawbacks. Although it reduces physical effort to some extent, the cart still requires a user to pull it from the front during operation. This method only reduces the towing force applied by the user to pull the cart, and the cart is incapable of carrying a person due to structural limitations. As a result, the user inevitably has to walk on foot during use, which easily leads to fatigue and adversely affects the user experience.

Therefore, there is an urgent need to design an electric folding wagon capable of being driven for outdoor usage to overcome one or more deficiencies in the prior art.

### SUMMARY

To achieve the above-mentioned technical objectives, the present disclosure adopts the following technical solutions: a novel manned folding electric cart, including: a folding cart body, where the folding cart body is folded and collapsed in a front-to-rear direction; a seat apparatus is arranged on a top portion of a front end of the folding cart body; a steering rod assembly is connected to a bottom portion of the front end of the folding cart body, at least one first wheel is connected to the steering rod assembly; an end of the folding cart body away from the steering rod assembly is provided with at least two second wheels, and the folding cart body is further provided with a power supply for providing power to the first wheel and/or the second wheels, and a controller for controlling the operation of the first wheel and/or the second wheels; the folding cart body includes a first rack and a second rack; one end of the first rack is connected to one end of the second rack, and each of two sides of the first rack is provided with a bracket assembly, and two ends of the bracket assembly on each side are respectively connected to support assemblies; and when the first rack and the second rack are folded and collapsed, the support assemblies at two sides are driven to fold simultaneously.

In a preferred embodiment, telescopic inner rods are respectively slidably arranged at two sides of one end inside the first rack, the telescopic inner rods are extendable out of the first rack to drive the steering rod assembly away from the first rack.

In a preferred embodiment, the steering rod assembly includes: a steering crossbar, and a steering rod; the first wheel is arranged below the steering crossbar, a pivot rod is inserted through a middle portion of the steering crossbar, and the pivot rod is rotatable relative to the steering crossbar in a horizontal direction; and a bottom portion of the pivot rod is connected to the first wheel, and the steering rod drives the first wheel to steer through the pivot rod.

In a preferred embodiment, the steering rod assembly further includes a sleeve rod; one end of the sleeve rod is pivotally connected to a top portion of the pivot rod; and the steering rod is slidably disposed inside the sleeve rod, the steering crossbar is pivotally connected to the telescopic inner rods.

In a preferred embodiment, a support frame is connected between two support assemblies at the same ends of two bracket assemblies; and horizontal adapter rods are respectively connected to top portions of two ends of the bracket assembly on each side, and the top portions of two ends of the bracket assembly are connected to the support assemblies through the adapter rods.

In a preferred embodiment, two first wheels are provided; and the two first wheels are respectively arranged at two ends of the steering crossbar, an end of the pivot rod away from the steering rod is movably connected to a steering connecting rod, and two ends of the steering connecting rod are respectively pivotally connected to the two first wheels.

In a preferred embodiment, bottom ends of the two support assemblies adjacent to the steering rod assembly are respectively provided with vertical first sliding slots; and a footplate is disposed between the two first sliding slots, two sides of a bottom end of the footplate are respectively provided with first sliding pins, and the bottom end of the footplate is slidably connected to the first sliding slots through the first sliding pins.

In a preferred embodiment, a bottom end of a bottom surface of the footplate is provided with at least one folded-position limiting pin for restricting translational movement of the steering rod assembly when the footplate is in a folded state, at least one pin hole adapted to the folded-position limiting pin is formed in a top surface of the steering crossbar, and a relief hole adapted to the pivot rod is further formed in a middle portion of a top end of the footplate.

In a preferred embodiment, a top end of the bottom surface of the footplate is provided with at least one unfolded-position limiting pin for restricting translational movement of the steering rod assembly when the footplate is in an unfolded state, and the unfolded-position limiting pin is adapted to the pin hole.

In a preferred embodiment, spaced pivot connecting lugs are arranged at the top portion of the pivot rod, and an insertion hole is formed between the two pivot connecting lugs; a protruding block is arranged at a bottom end of the sleeve rod, the protruding block is inserted between the two pivot connecting lugs and is pivotally connected via a pivot shaft; and a folding-limiting member is movably disposed inside the bottom end of the sleeve rod; and when the steering rod presses against the folding-limiting member, one end of the folding-limiting member protrudes from the protruding block and is inserted into the insertion hole to limit the movement of the sleeve rod relative to the pivot rod.

In a preferred embodiment, a handle ring is disposed at a top portion of the steering rod; and two folding grooves are respectively formed on two sides of the handle ring, grip rods are pivotally connected to same ends of the two folding grooves, and one of the grip rods is electrically connected to the controller for controlling operating speeds of the first wheel and/or the second wheels.

In a preferred embodiment, corresponding limiting holes are respectively formed in a side wall of the steering rod and a side wall of the sleeve rod, limiting pins are further disposed inside the steering rod, and the limiting pins are adapted to the limiting holes; a limiting-pin button is disposed inside a bottom end of the handle ring, and the limiting-pin button is configured to drive the limiting pins to extend and retract.

In a preferred embodiment, a braking device is further disposed on the steering crossbar, and the braking device is connected to the first wheels.

In a preferred embodiment, a folding-limiting sleeve is sleeved at a pivotal connection position between each telescopic inner rod and the steering crossbar, a sleeve return spring is disposed at an end of the folding-limiting sleeve facing the steering crossbar, and the folding-limiting sleeve is located at the connection position between the telescopic inner rod and the steering crossbar under the force of the sleeve return spring.

In a preferred embodiment, the seat apparatus is made of a rigid material, both ends of the seat apparatus are respectively pivotally connected to two sides of the top portion of the front end of the folding cart body, and the seat apparatus can be flipped forward or backward relative to the folding cart body.

In a preferred embodiment, the seat apparatus is made of a flexible material; and the seat apparatus is arranged on the top portion of the front end of the folding cart body, and a front side and/or a rear side of the seat apparatus is provided with support rods connected to the folding cart body.

In a preferred embodiment, ends of the telescopic inner rods away from the second rack are pivotally connected to the steering rod assembly.

The present disclosure has the following beneficial effects: the seat apparatus is arranged on a top portion of a front end of the folding cart body, so as to implement a seating function and to enable use of the electric cart to be more labor-saving. In addition, the steering rod assembly is slidably connected to the folding cart body, so that the steering rod assembly can extend out, to increase the distance between a support stress point of the seat apparatus and a support point of the first wheel, so that the stability of manned driving is improved and safety performance is improved. Moreover, the front end of the folding cart body is provided with a footplate, to facilitate foot placement and standing driving, so that the electric cart can be used in more diverse situations. Moreover, the electric cart can be folded for storage, thereby providing enhanced convenience.

### BRIEF DESCRIPTION OF THE DRAWINGS

FIG. 1 is a schematic structural diagram of the present disclosure.

FIG. 2 is an exploded view of a folding cart body according to the present disclosure.

FIG. 3 is a schematic structural diagram of a footplate according to the present disclosure.

FIG. 4 is a schematic structural diagram of a steering rod assembly according to the present disclosure.

FIG. 5 is a schematic structural diagram of a steering rod according to the present disclosure.

FIG. 6 is a sectional view of a folding-limiting member according to the present disclosure.

FIG. 7 is a diagram illustrating a first towing use state of the present disclosure.

FIG. 8 is a diagram illustrating a second towing use state of the present disclosure.

FIG. 9 is a diagram illustrating a folded state of the present disclosure.

FIG. 10 is a circuit diagram of a controller according to the present disclosure.

FIG. 11 is an electrical connection block diagram of the present disclosure.

Reference numerals in the accompanying drawings:
1. folding cart body; 11. first rack; 12. second rack; 13. bracket assembly; 131. support frame; 132. adapter rod; 133. first sliding slot; 134. second sliding slot; 14. support assembly; 15. second wheel; 16. power supply; 17. controller; 18. telescopic inner rod; 2. steering rod assembly; 21. steering crossbar; 211. pivot rod; 212. steering connecting rod; 213. pin hole; 214. pivot connecting lug; 215. insertion hole; 216. braking device; 217. folding-limiting sleeve; 218. guide post; 219. extension block; 22. steering rod; 221. handle ring; 222. folding groove; 223. grip rod; 224. limiting device; 225. control button; 226. display device; 227. limiting hole; 228. limiting pin; 229. limiting-pin button; 23. sleeve rod; 231. protruding block; 232. folding-limiting member; 233. folding-limiting return spring; 234. pivot-shaft sliding hole; 24. first wheel; 3. footplate; 31. first sliding pin; 32. second sliding pin; 33. folded-position limiting pin; 34. unfolded-position limiting pin; 35. relief hole; and 4. seat apparatus.

### DETAILED DESCRIPTIONS OF THE EMBODIMENTS

To make the objectives, features, and advantages mentioned above of the present disclosure more apparent and easily understood, the specific implementation of the present disclosure will be described in detail below with reference to the drawings. Many specific details are set forth in the following description to facilitate thorough understanding of the present disclosure. However, the present disclosure may be implemented in many other ways different from those described herein, similar improvements may be made by those skilled in the art without departing from the connotation of the present disclosure, and therefore, the present disclosure is not limited by the specific implementation disclosed below.

In the description of the embodiments of the present disclosure, it should be noted that, unless otherwise expressly specified and defined, the terms “connection/connected” and “mounted” should be interpreted broadly. For example, “connection” may refer to a detachable connection or a non-detachable connection; it may refer to a direct connection or an indirect connection through an intermediate medium. In addition, “communication” may refer to direct communication or indirect communication through an intermediate medium. The term “fixed” refers to being connected such that a relative positional relationship remains unchanged after connection. Directional terms such as “inner,” “outer,” “top,” “bottom,” and the like used in the embodiments of the present disclosure are for illustrative purposes only, with reference to the orientation shown in the figures. Therefore, the directional terms used herein are for better and clearer explanation and understanding of the embodiments, rather than indicating or implying that the apparatus or element must have a specific orientation, or be constructed or operated in a specific orientation, therefore, these terms cannot be understood as limitation on the embodiments of the present disclosure.

In the description of the embodiments the present disclosure, the terms “first”, and “second” are used for descriptive purposes only, and cannot be construed as indicating or implying relative importance or implicitly indicating the number of technical features indicated. Thus, features defined by “first” and “second” may explicitly or implicitly include one or more of the features.

In the embodiments of the present disclosure, the term “and/or” represents merely an association relationship describing associated objects, indicating that there may be three types of relationships, for example, A and/or B, which means three types of situation, that is, the existence of A alone, the existence of both A and B, and the existence of B alone. In addition, the character “/” herein generally indicates that the associated objects are in an “or” relationship.

Reference in the specification of the present disclosure to “an example” or “some examples”, etc. means that one or more examples of the present disclosure include particular features, structures or characteristics described in combination with the examples. Accordingly, phrases such as “in one embodiment,” “in some embodiments,” “in other embodiments,” and “in further embodiments,” appearing in difference parts in the specification do not necessarily refer to the same embodiment, but rather mean “one or more but not all of the embodiments,” unless specifically emphasized otherwise. The terms “include”, “comprise”, “have”, and their variations mean “including but not limited to”, unless specifically emphasized otherwise. Therefore, the present disclosure is not limited to the specific embodiments disclosed below.

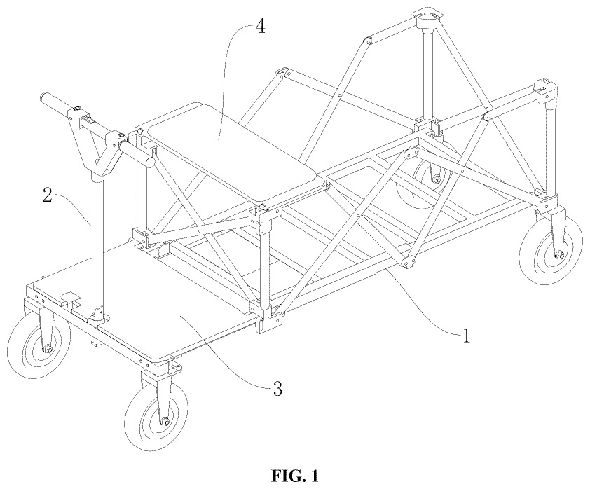

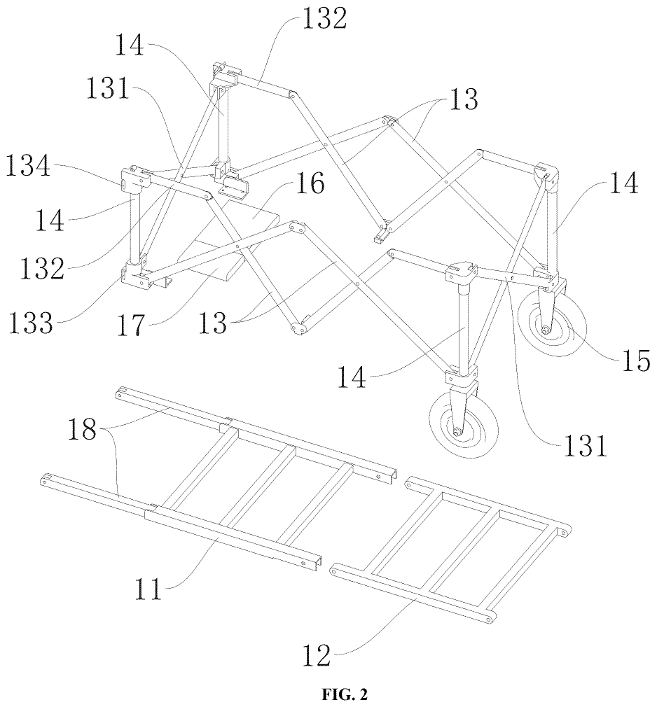

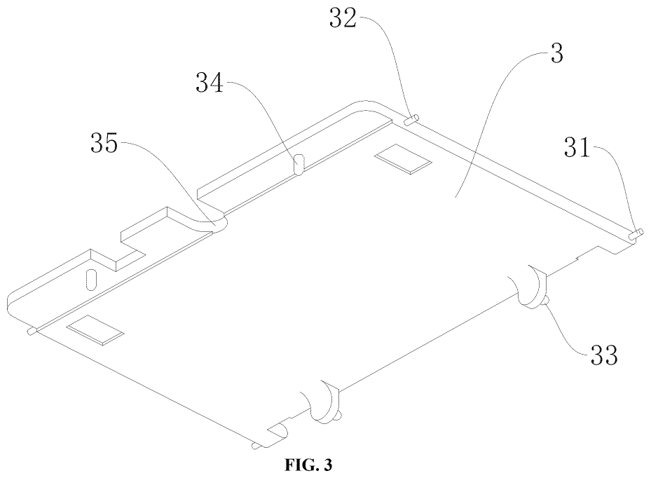

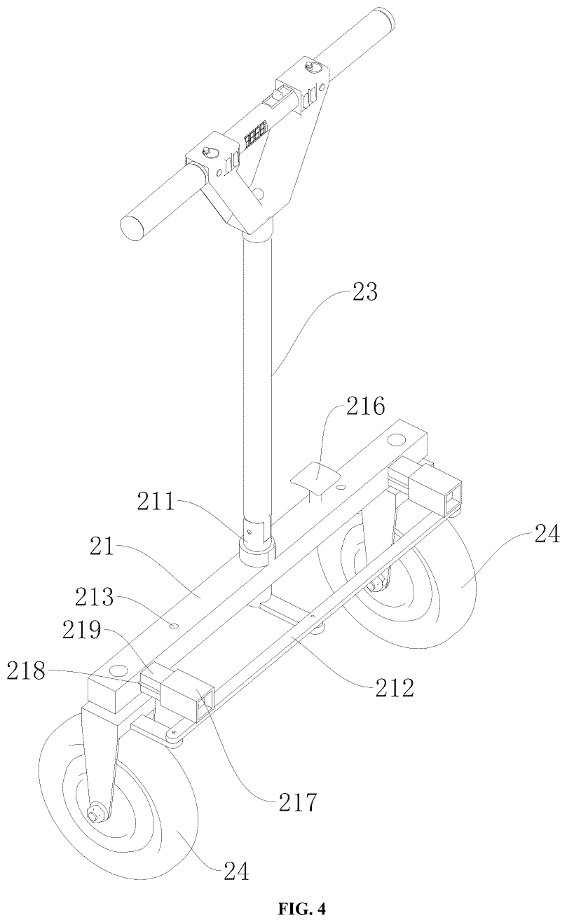

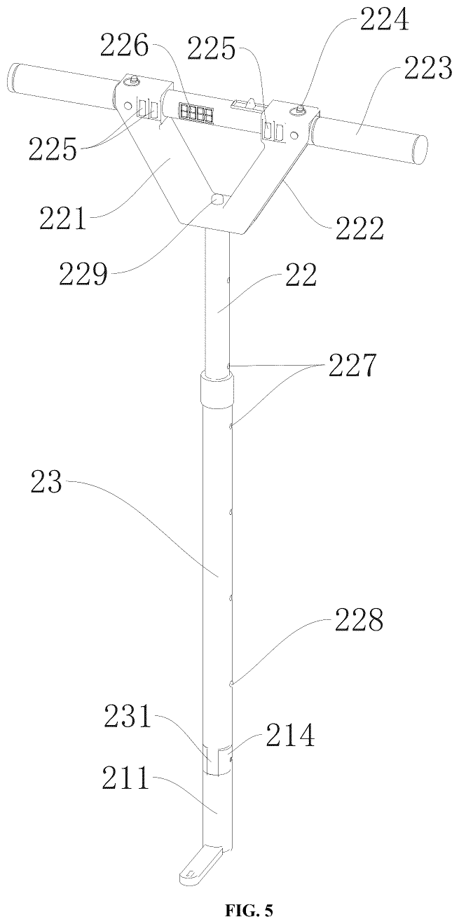

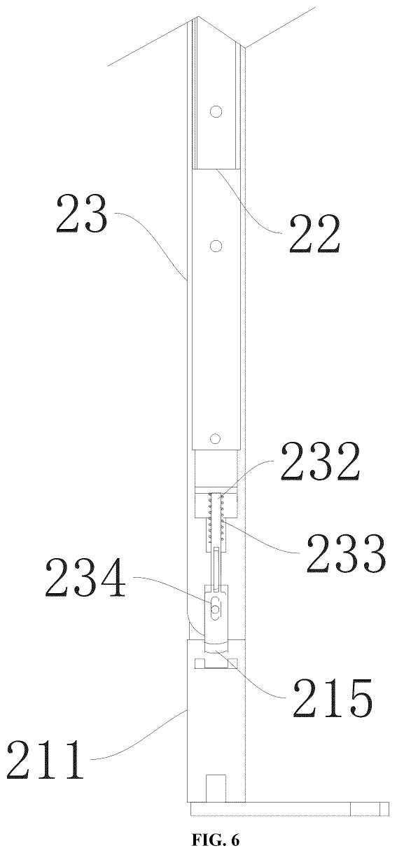

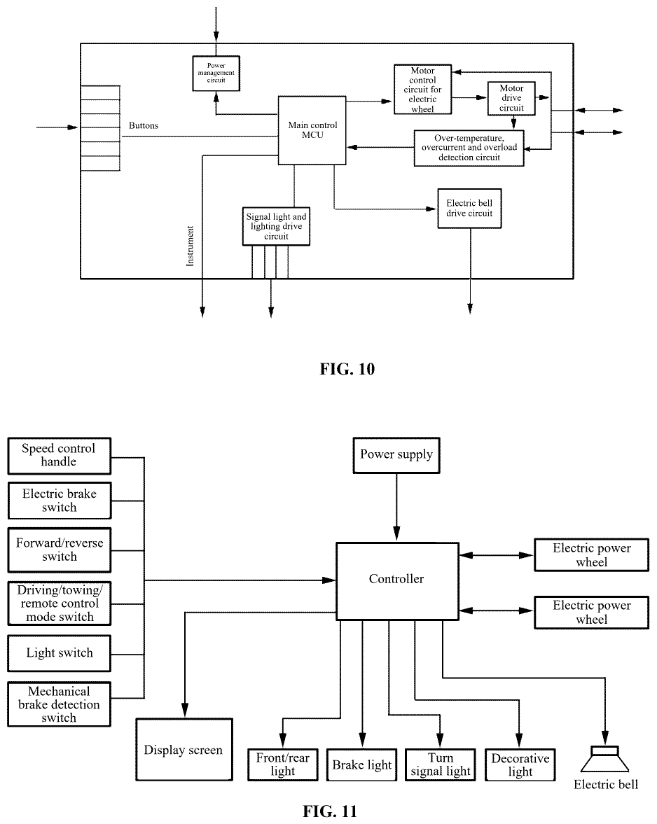

As shown in FIGS. 1-11, the present disclosure provides a novel manned folding electric cart, including: a folding cart body 1, where the folding cart body 1 is folded and collapsed in a front-to-rear direction; a seat apparatus 4 is arranged on a top portion of a front end of the folding cart body 1; and a steering rod assembly 2 is connected to a bottom portion of the front end of the folding cart body 1, at least one first wheel 24 is connected to the steering rod assembly 2; an end of the folding cart body 1 away from the steering rod assembly 2 is provided with at least two second wheels 15, and the folding cart body 1 is further provided with a power supply 16 for providing power to the first wheel 24 and/or the second wheels 15, and a controller 17 for controlling the operation of the first wheel 24 and/or the second wheels 15; and
specifically, the folding cart body 1 is structured as a folding cart that is folded in the front-to-rear direction; the seat apparatus 4 is rotatably arranged on the top portion of the front end of the folding cart body 1, and the seat apparatus 4 is configured to allow a user to sit on the folding cart body 1; the steering rod assembly 2 is connected to a bottom portion of the folding cart body 1, at least one first wheel 24 is arranged at a bottom portion of the steering rod assembly 2, two second wheels 15 that are fixedly connected to the folding cart body 1 are respectively arranged at two sides of the end of the folding cart body 1 away from the steering rod assembly 2, and a stable triangular structure is formed between the first wheel 24 and the second wheels 15, to ensure stable traveling of the folding cart body 1 when carrying cargo and to reduce the possibility of tipping over. Preferably, in this embodiment, the first wheel 24 is pivotally arranged to be rotatable for controlling a traveling direction, while the second wheels 15 are fixed and non-rotatable, thereby avoiding the situation of uncontrollable direction during traveling. The front end of the folding cart body 1 is further provided with the controller 17 for controlling the operation of the first wheel 24 and/or the second wheels 15 and the power supply 16 for providing power to the first wheel 24 and/or the second wheels 15, such that the first wheel 24 and/or the second wheels 15 are capable of operating autonomously under the control of the controller 17 to drive the folding cart body 1 to travel, thereby achieving an electric self-propelled effect. Meanwhile, the steering rod assembly 2 is configured to control steering of the first wheel 24. A user can sit on the seat apparatus 4, thereby realizing a manned driving function, such that the folding cart does not require manual pulling during use, improving convenience of use, and reducing labor intensity of the user.

It should be noted that the first wheel 24 and the second wheels 15 may be powered driving wheels, or either of the first wheel 24 or the second wheels 15 may be selected as a driving wheel, depending on actual use requirements. In this embodiment, the first wheel 24 is preferably selected as the driving wheel. Since the first wheel is located at the same end as the steering rod assembly 2, wiring is more convenient and shorter in length. In addition, a front-wheel-drive configuration offers better performance in passing through uneven road surfaces, such as curbs, and has stronger passability. Moreover, the front-wheel-drive configuration offers greater traction, thereby achieving better traveling performance under heavy loads.

Specifically, the driving wheel is an electric wheel with a motor arranged therein according to the prior art, such as a driving wheel used in electric bicycles or electric motorcycles. Therefore, the specific structure of the electric wheels will not be described in detail herein.

Further, the folding cart body 1 includes: a first rack 11 and a second rack 12; one end of the first rack 11 is connected to one end of the second rack 12, and each of two sides of the first rack 11 is provided with a bracket assembly 13, and two ends of the bracket assembly on each side 13 are respectively connected to support assemblies 14. Telescopic inner rods 18 are respectively slidably disposed at two ends inside the first rack 11, and ends of the telescopic inner rods 18 away from the second rack 12 are pivotally connected to the steering rod assembly 2. The telescopic inner rods 18 can extend out of the first rack 11 to drive the steering rod assembly 2 away from the first rack 11; and
specifically, the folding cart body 1 includes the first rack 11, the second rack 12, the bracket assemblies 13, and the support assemblies 14; four support assemblies 14 are provided and arranged in a rectangular layout, the first rack 11 and the second rack 12 are both located within the rectangle defined by the support assemblies 14, and one end of the first rack 11 is hinged to one end of the second rack 12. Two opposite ends of the first rack 11 and the second rack 12, respectively facing away from each other, have two sides that are pivotally connected to corresponding support assemblies 14. In addition, one bracket assembly 13 is connected between two support assemblies 14 on the same side, the bracket assembly 13 has an “X” shaped structure, such that when two ends of the bracket assembly 13 are pressed toward each other, the bracket assembly is foldable toward a middle portion thereof. Thus, when the first rack 11 and the second rack 12 are folded and collapsed, the bracket assemblies 13 on both sides are folded synchronously. When unfolded, the bracket assemblies 13 are capable of sharing weight borne by the first rack 11 and the second rack 12. Preferably, in order to reduce an overall weight of the folding cart body 1, the first rack 11 and the second rack 12 are of hollow structures. The telescopic inner rods 18 are slidably disposed at two sides inside an end of the first rack 11 away from the second rack 12. A length of each telescopic inner rod 18 is less than a length of the first rack 11. The telescopic inner rods 18 are capable of partially extending out of the first rack 11 when needed. A front end of each telescopic inner rod 18 is pivotally connected to the steering rod assembly 2, and the telescopic inner rods 18 are rotatable relative to the steering rod assembly 2 in a vertical direction, such that when the first rack 11 and the second rack 12 are folded and collapsed, the telescopic inner rods 18 are folded relative to the steering rod assembly 2. When extended, the telescopic inner rods 18 are capable of pushing the steering rod assembly 2 and the first wheel 24 away from the first rack 11. A maximum extension distance of each telescopic inner rod 18 is less than its own length, such that the folding cart body 1 can be lifted through cooperation between the telescopic inner rods 18 and the first rack 11. In this case, when the user sits on the seat apparatus 4, strong support can be provided for the user.

It should be noted that a fabric pocket (not shown in the figures) is further provided inside the folding cart body 1, and is configured to enclose items placed inside the folding cart body and prevent the items from falling out.

Further, a bottom surface of the end of the first rack 11 connected to the second rack 12 has an opening, and a portion of an end of the second rack 12 adjacent to the first rack 11 is inserted into the first rack 11 and pivotally connected to the first rack 11; and
specifically, the bottom surface of the end of the first rack 11 connected to the second rack 12 has an opening (not shown in the figures), where a length of the opening is less than half a length of the first rack 11. One end of the second rack 12 is inserted into the end of the first rack 11 having the opening, and an insertion distance is less than the length of the opening, thereby preventing the first rack 11 and the second rack 12 from being unable to fold relative to each other. In addition, the structure of having the opening on the bottom surface can prevent the first rack 11 and the second rack 12 from sagging due to the weight of carried items, thereby improving the load-bearing performance of the first rack 11 and the second rack 12.

Further, a support frame 131 is connected between two support assemblies 14 at the same ends of two bracket assemblies 13, horizontal adapter rods 132 are respectively connected to top portions of two ends of the bracket assembly 13 on each side, and the top portions of two ends of the bracket assembly 13 are connected to the support assemblies 14 through the adapter rods 132; and
specifically, in order to improve overall stability of the folding cart body 1, the support frames 131 are respectively connected between two support assemblies 14 at the front end and between the support assemblies 14 at the rear end of the folding cart body 1. Each support frame 131 may be a line-shaped, an “X” shaped or in other shapes. By providing the support frame 131, two support assemblies 14 at the same end are effectively prevented from inclining toward a middle portion. In addition, the support frames 131 can also serve to support the seat apparatus 4 and share the weight during passenger carrying. Since the bracket assemblies 13 also have an “X” shaped structure, heights of two ends thereof increase when folded. In addition, the two ends of each bracket assembly 13 are connected to the support assemblies 14. Therefore, in order to avoid motion interference that would prevent the bracket assemblies 13 from being folded, a conventional approach is to configure the support assemblies 14 as telescopic structures. However, telescopic structures tend to adversely affect stability of the support assemblies 14. Therefore, in this embodiment, the horizontal adapter rods 132 are preferably pivotally connected to top portions of two ends of each bracket assembly 13, respectively, and another end of each adapter rod 132 is pivotally connected to a top of the corresponding support assembly 14. Since a bottom portion of each bracket assembly 13 is restricted from movement, the bracket assembly 13 is folded by moving its top portion. Therefore, the folding of the bracket assembly 13 can be achieved by providing the adapter rods 132 at the tops of the two ends of the bracket assembly 13, without the need of configuring the support assemblies 14 as telescopic structures. Moreover, due to horizontal arrangement, the adapter rods 132 can also function to support the seat apparatus 4.

It should be noted that a length of each adapter rod 132 needs to be matched with a moving distance of the top portion of the corresponding bracket assembly 13; otherwise, unfolding or folding of the bracket assembly 13 may be affected.

Further, in this embodiment, the steering rod assembly 2 includes: a steering crossbar 21, a steering rod 22, and a sleeve rod 23; the first wheel 24 is arranged below the steering crossbar 21, a pivot rod 211 is inserted through a middle portion of the steering crossbar 21, and the pivot rod 211 is rotatable relative to the steering crossbar 21 in a horizontal direction; one end of the sleeve rod 23 is pivotally connected to a top portion of the pivot rod 211; and the steering rod 22 is slidably disposed inside the sleeve rod 23, and the steering crossbar 21 is pivotally connected to the telescopic inner rods 18; and a bottom portion of the pivot rod 211 is connected to the first wheel 24, and the steering rod 22 drives the first wheel 24 to steer through the pivot rod 211; and
specifically, the steering rod assembly 2 includes the steering crossbar 21, the steering rod 22, and the sleeve rod 23; two ends of the steering crossbar 21 are respectively pivotally connected to the telescopic inner rods 18; the first wheels 24 are arranged at both end portions of the steering crossbar 21; the pivot rod 211 is rotatably disposed at a middle portion of the steering crossbar 21, and the pivot rod 211 is rotatable horizontally on the steering crossbar 21; a bottom end of the pivot rod 211 is connected to the first wheels 24, and the rotation of the first wheels 24 is controlled by the pivot rod 211; and the sleeve rod 23 is pivotally connected to a top end of the pivot rod 211, the steering rod 22 is slidably disposed inside the sleeve rod 23, and the steering rod 22 is extendable out of the sleeve rod 23. When it is necessary to adjust a height of the steering rod 22, the steering rod 22 can be pulled out from the sleeve rod 23. When it is necessary to tow the folding cart body 1, the sleeve rod 23 can be rotated to an inclined position relative to the pivot rod 211, thereby facilitating towing. When the telescopic inner rods 18 extend, the steering crossbar 21 and the first wheels 24 are driven to move synchronously, such that a distance between support points of the first wheels 24 and support points of the second wheels 15 is increased, allowing a support point of the seat apparatus 4 to be completely located between the first wheels 24 and the second wheels 15, thereby improving the stability of the electric cart when carrying the passenger.

Further, two first wheels 24 are provided; where the two first wheels 24 are respectively arranged at two ends of the steering crossbar 21, an end of the pivot rod 211 away from the sleeve rod 23 is movably connected to a steering connecting rod 212, and two ends of the steering connecting rod 212 are respectively pivotally connected to the two first wheels 24; and
specifically, since a three-wheel structure is prone to tipping over during turning, in order to improve traveling stability of the folding cart body 1 and enhance safety of a rider, two first wheels 24 are preferably provided in this embodiment. The two first wheels 24 are respectively arranged at two end portions of the steering crossbar 21. To facilitate simultaneous control of synchronous steering of the two first wheels 24 in a same direction, the steering connecting rod 212 is movably connected to a bottom portion of the pivot rod 211, and two ends of the steering connecting rod 212 are respectively pivotally connected to the corresponding first wheels 24. When the pivot rod 211 rotates, the steering connecting rod 212 is driven to translate in a left-right direction, and the steering connecting rod 212 then drives the two first wheels 24 to turn left or right, thereby achieving synchronous control of the two first wheels 24.

Further, in this embodiment, bottom ends of the two support assemblies 14 adjacent to the steering rod assembly 2 are respectively provided with vertical first sliding slots 133; and a footplate 3 is disposed between the two first sliding slots 133, two sides of a bottom end of the footplate 3 are respectively provided with first sliding pins 31, and the bottom end of the footplate 3 is slidably connected to the first sliding slots 133 through the first sliding pins 31; and
specifically, when the steering rod assembly 2 is translated and the user sits on the seat apparatus 4, a gap exists between the two telescopic inner rods 18, it is inconvenient to place feet. Although the feet may be placed on the telescopic inner rods 18, such posture requires legs to be spread apart and is aesthetically unfavorable. Therefore, in this embodiment, externally arranged vertical first sliding slots 133 are respectively formed on bottom portions of the two support assemblies 14 of the first rack 11, that is, the first sliding slots 133 are located on outer surfaces of the support assemblies 14. The footplate 3 is disposed between the two first sliding slots 133, two sides of the bottom end of the footplate 3 are respectively provided with first sliding pins 31, and the footplate 3 is slidably connected to the first sliding slots 133 through the first sliding pins 31, such that the footplate 3 is restricted to a position in front of the two support assemblies 14. Through cooperation between the first sliding pins 31 and the first sliding slots 133, the footplate 3 is flipped relative to the support assemblies 14. When the steering rod assembly 2 is not extended, the footplate 3 is vertically positioned against a front side of the support assemblies 14. After the steering rod assembly 2 is extended, the footplate 3 can be flipped downward to rest on the telescopic inner rods 18 and the steering crossbar 21. In this case, when the user sits on the seat apparatus 4, the user can place feet on the footplate 3, and the arrangement of the footplate 3 also allows the user to ride while standing.

In addition, in order to ensure that the footplate 3 can be vertically positioned against a front side of the support assemblies 14 without manual restriction to prevent flipping, two second sliding slots 134 are respectively formed on top portions of the two support assemblies 14 provided with the first sliding slots 133; notches (not shown in the figures) are formed on the top portions of the second sliding slots 134. In addition, second sliding pins 32 are respectively arranged on two sides of an end of the footplate 3 away from the first sliding pins 31, and the second sliding pins 32 are adapted to the second sliding slots 134, such that the footplate 3 is vertically restricted at the front end of the folding cart body 1 through cooperation between the second sliding pins 32 and the second sliding slots 134. When flipping of the footplate is required, the footplate 3 only needs to be lifted to disengage the second sliding pins 32 from the second sliding slots 134 through the notches, thereby enabling flipping of the footplate 3.

It should be noted that, since the footplate 3 is located above the telescopic inner rods 18, and the footplate 3 is capable of flipping relative to the support assemblies 14, in order to avoid interference by the telescopic inner rods 18 during flipping, an avoidance structure corresponding to the telescopic inner rods 18 is disposed at an end of the footplate adjacent to the folding cart body 1 when the footplate 3 is in a horizontal position, allowing the footplate 3 to flip normally.

Further, a bottom end of a bottom surface of the footplate 3 is provided with at least one folded-position limiting pin 33 for restricting translational movement of the steering rod assembly 2 when the footplate 3 is in a folded state, and a top end of the bottom surface of the footplate 3 is provided with at least one unfolded-position limiting pin 34 for restricting translational movement of the steering rod assembly 2 when the footplate 3 is in an unfolded state. At least one pin hole 213 adapted to the folded-position limiting pin 33 and the unfolded-position limiting pin 34 is formed in a top surface of the steering crossbar 21, and a relief hole 35 adapted to the pivot rod 211 is further formed in a middle portion of a top end of the footplate 3; and
specifically, at least one folded-position limiting pin 33 is disposed at an end of the footplate adjacent to the folding cart body 1 when the footplate 3 is in the horizontal position, and the folded-position limiting pin 33 is spaced from and arranged parallel to the bottom surface of the footplate 3. At least one unfolded-position limiting pin 34 is disposed at an end of the footplate away from the folding cart body 1 when the footplate 3 is in the horizontal position, and the pin holes 213 adapted to the folded-position limiting pin 33 and the unfolded-position limiting pin 34 are formed in the top surface of the steering crossbar 21. When the footplate 3 is in the horizontal position, the unfolded-position limiting pin 34 is inserted into the pin hole 213, such that the steering crossbar 21 is prevented from translating due to the restriction imposed by the footplate 3, and the steering crossbar 21 is allowed to translate only after the footplate 3 is lifted. When the steering crossbar 21 needs to be retracted, the footplate 3 must first be lifted to cause the unfolded-position limiting pin 34 to disengage from the pin hole 213, and the footplate 3 is vertically positioned against the front side of the support assembly 14, such that the folded-position limiting pin 33 changes from facing toward the folding cart body 1 to facing downward. After the steering crossbar 21 retracts by a predetermined distance, further retraction is restricted by the folded-position limiting pin 33. In this case, the footplate 3 needs to be pulled upward. Due to the arrangement of the first sliding slots 133, the footplate 3 moves upward when subjected to an upward force, such that the steering crossbar 21 is no longer blocked by the folded-position limiting pin 33 and can continue to retract until reaching a limit position. In this case, after the footplate 3 is released, since the folded-position limiting pin 33 corresponds to the pin hole 213, the folded-position limiting pin 33 is directly inserted into the pin hole 213. Under the restriction of the folded-position limiting pin 33, the steering crossbar 21 cannot translate after being retracted. Thus, limiting of the steering crossbar 21 in an extended position is achieved by the unfolded-position limiting pin 34 on the footplate 3, and limiting of the steering crossbar 21 in a retracted position is achieved by the folded-position limiting pin 33.

Further, in this embodiment, a folding-limiting sleeve 217 is sleeved at a pivotal connection position between each telescopic inner rod 18 and the steering crossbar 21, a sleeve return spring is disposed at an end of the folding-limiting sleeve 217 facing the steering crossbar 21, and the folding-limiting sleeve 217 is located at the connection position between the telescopic inner rod 18 and the steering crossbar 21 under the force of the sleeve return spring; and
specifically, since the telescopic inner rods 18 can be completely retracted into the first rack 11, while the steering crossbar 21 is restricted by the support assemblies 14 and spaced apart from the first rack 11, in this case, rotation of the telescopic inner rods 18 may be restricted by the support frames 131, preventing the telescopic inner rods from rotating with the first rack 11. Therefore, horizontally extending extension blocks 219 are respectively provided at two ends of each telescopic inner rod 18 to fill a gap between the telescopic inner rod 18 and the first rack 11, such that the telescopic inner rods 18 can be completely retracted into the first rack 11 and have a rotation center coaxial with that of the first rack 11. Since steering crossbar 21 is pivotally connected to the telescopic inner rods 18, in order to prevent the telescopic inner rods 18 from rotating relative to steering crossbar 21 during normal use, the folding-limiting sleeve 217 is movably sleeved onto the extension block 219; sleeve return springs (not shown in the figures) are respectively arranged on two sides of an end of the folding-limiting sleeve 217 facing the steering crossbar 21; and under the force of the sleeve return springs, the folding-limiting sleeve 217 is pushed against a pivotal connection position between the extension block 219 and the telescopic inner rods 18, such that rotation of the telescopic inner rods 18 relative to the extension block 219 is restricted by the folding-limiting sleeve 217. When the steering crossbar 21 is retracted to the limit position, the folding-limiting sleeve 217 first contacts the first rack 11, and the folding-limiting sleeve 217 slides toward the steering crossbar 21 due to compression by the first rack 11, and the sleeve return springs are simultaneously pressed. When the steering crossbar 21 is fixed by the folded-position limiting pin 33, the folding-limiting sleeve 217 is disengaged from the pivotal connection position between the extension block 219 and the telescopic inner rods 18, in this case, the telescopic inner rods 18 are rotatable relative to the extension block 219. When the steering crossbar 21 extends, the folding-limiting sleeve is no longer pressed by the first rack 11 and slides back to the pivotal connection position between the extension block 219 and the telescopic inner rods 18 under the elastic force of the sleeve return springs.

It should be noted that guide posts 218 are respectively arranged on two sides of the end of the folding-limiting sleeve 217 facing the steering crossbar 21; and the guide posts 218 can be inserted into the steering crossbar 21, and the sleeve return springs are arranged on outer sides of the guide posts 218, thereby preventing displacement of the sleeve return springs during compression and avoiding abnormal deformation of the sleeve return springs.

Further, spaced pivot connecting lugs 214 are arranged at the top portion of the pivot rod 211, and an insertion hole 215 is formed between the two pivot connecting lugs 214; a protruding block 231 is arranged at a bottom end of the sleeve rod 23, the protruding block 231 is inserted between the two pivot connecting lugs 214 and is pivotally connected via a pivot shaft; and a folding-limiting member 232 is movably disposed inside the bottom end of the sleeve rod 23; and when the steering rod 22 presses against the folding-limiting member 232, one end of the folding-limiting member 232 protrudes from the protruding block 231 and is inserted into the insertion hole 215; and
specifically, the spaced pivot connecting lugs 214 are arranged at the top portion of the pivot rod 211, and the protruding block 231 is arranged at the bottom of the sleeve rod 23; the protruding block 231 is adapted to a distance between the two pivot connecting lugs 214, such that the protruding block 231 can be inserted between the two pivot connecting lugs 214. Further, in order to achieve a pivot connection, the protruding block 231 and the two pivot connecting lugs 214 are connected via the pivot shaft, enabling rotation of the sleeve rod 23 relative to the pivot rod 211. In order to prevent rotation of the sleeve rod 23 relative to the pivot rod 211 when not needed, the folding-limiting member 232 is slidably disposed inside the bottom of the sleeve rod 23. The folding-limiting member 232 can slide up and down within the bottom of the sleeve rod 23, and one end of the folding-limiting member 232 can protrude out of the protruding block 231. In addition, a folding-limiting return spring 233 is disposed on an end of the folding-limiting member 232 located inside the sleeve rod 23. When the folding-limiting member 232 is pressed by the steering rod 22, one end of the folding-limiting member 232 protrudes from the protruding block 231, and the folding-limiting member 232 synchronously presses against the folding-limiting return spring 233 at the same time. When the force applied by the steering rod 22 is removed, the folding-limiting member 232 retracts back into the sleeve rod 23 under the restoring force of the folding-limiting return spring 233. To enable cooperation and fixation between the folding-limiting member 232 in the sleeve rod 23 and the pivot rod 211, the insertion hole 215 is formed between the two pivot connecting lugs 214 at the top portion of the pivot rod 211. When one end of the folding-limiting member 232 protrudes from the protruding block 231 and is inserted into the insertion hole 215, rotation of the sleeve rod 23 relative to the pivot rod 211 is restricted through cooperation between the folding-limiting member 232 and the insertion hole 215. Specifically, a pivot-shaft sliding hole 234 is formed in a middle portion of the folding-limiting member 232, and the pivot shaft pivotally connecting the sleeve rod 23 and the pivot rod 211 is located within the pivot-shaft sliding hole 234, such that the folding-limiting member 232 can slide between the sleeve rod 23 and the pivot rod 211. After the folding-limiting member 232 is no longer pressed by the steering rod 22, the folding-limiting return spring 233 will push the folding-limiting member 232 upward. Due to the restriction imposed by the pivot shaft, an upward movement distance of the folding-limiting member 232 is limited and can be adjusted by a length of the pivot-shaft sliding hole 234.

Further, in this embodiment, a handle ring 221 is disposed at a top portion of the steering rod 22; two folding grooves 222 are respectively formed on two sides of the handle ring 221, grip rods 223 are pivotally connected to same ends of the two folding grooves 222, where one of the grip rods 223 is electrically connected to the controller 17 for controlling an operating speed of the first wheel 24 and/or the second wheels 15; ends of the grip rods 223 connected to the folding grooves 222 are further provided with limiting devices 224 for limiting the grip rods when the grip rods 223 are received within the folding grooves 222 or when the grip rods 223 are in a horizontal position relative to the handle ring 221. A plurality of control buttons 225 and a display device 226 are further arranged on the handle ring 221, where the plurality of control buttons 225 and the display device 226 are respectively electrically connected to the controller 17 via wires; corresponding limiting holes 227 are respectively formed in a side wall of the steering rod 22 and a side wall of the sleeve rod 23, limiting pins 228 are further disposed inside the steering rod 22, and the limiting pins 228 are adapted to the limiting holes 227; a limiting-pin button 229 is disposed inside a bottom end of the handle ring 221, and the limiting-pin button 229 is configured to drive the limiting pins 228 to extend and retract; and a braking device 216 is further disposed on the steering crossbar 21, and the braking device 216 is connected to the first wheels 24; and
specifically, the handle ring 221 is disposed at the top of the steering rod 22, and the handle ring 221 may be shaped as an inverted trapezoid, or a triangle, or a rectangle, or a circle, or other polygonal shapes for the convenience of the user to pull. Two folding grooves 222 are respectively formed on two sides of the handle ring 221, a grip rod 223 is pivotally connected at an end of the folding-limiting sleeve, and the grip rod 223 may be received within the folding groove 222 when not in use, and the grip rod 223 may be rotated to a horizontal position when needed. In order to better suit the common driving habits. One of the grip rods 223 may be configured as a rotatable grip, that is, the grip rod 223 may be rotated in place on the handle ring 221, similar to a throttle grip of an electric bicycle, thereby controlling rotational speeds of the first wheels 24 through a rotation angle thereof. The limiting devices 224 are disposed on top surfaces of ends of the grip rods 223 connected to the folding grooves 222, the limiting devices 224 are a detent-pin structure with an internal spring, and one limiting hole 227 adapted to the limiting devices 224 are formed at the ends of the grip rods 223 connected to the folding grooves 222, and are configured to limit the grip rods 223 when the grip rods 223 are in the horizontal position relative to the handle ring 221 or when the grip rods are received. The plurality of control buttons 225 are further arranged on the handle ring 221. The control buttons 225 include, but are not limited to, a forward/reverse button, a driving/towing mode switching button, a towing-assist speed control button, a headlight switch button, a horn button, a turn signal control button, and the like. The specific arrangement may refer to control button designs of electric bicycles in the prior art. The handle ring 221 is further provided with the display device 226 for displaying information such as battery level and speed. The control buttons 225 and the display device 226 are respectively electrically connected to the controller 17 via wires;
the corresponding limiting holes 227 are respectively formed in the side wall of the steering rod 22 and the side wall of the sleeve rod 23, and a limiting pin 228 is disposed inside the steering rod 22, and the limiting pin 228 is adapted to the limiting holes 227. A limiting-pin button 229 is further disposed on the handle ring 221. The limiting pin 228 is driven by pressing the limiting-pin button 229 to extend out of the steering rod 22 and engage with the limiting holes 227 in the steering rod 22 and the sleeve rod 23, thereby limiting the movement of the steering rod 22 and preventing the steering rod 22 from freely sliding within the sleeve rod 23. The specific cooperation between the limiting-pin button 229 and the limiting pin 228 may refer to limiting structures of luggage pull rods in the prior art or a structure disclosed in Chinese Patent CN201821724858.2. Therefore, it will not be described in further detail herein; and
the braking device 216 for braking is further disposed on the steering crossbar 21. The braking device 216 adopts a foot-operated brake structure used in conventional tricycles. The braking device 216 is connected to a brake structure of the two first wheels 24, and braking of the first wheels 24 is achieved by pressing the braking device 216.

Further, in this embodiment, the seat apparatus 4 is made of a rigid material, both ends of the seat apparatus 4 are respectively pivotally connected to two sides of the top portion of the front end of the folding cart body, and the seat apparatus 4 may be flipped forward or backward relative to the folding cart body; and
specifically, in order to improve the load-bearing stability of the seat apparatus 4 and load capacity of the seat apparatus 4, the seat apparatus 4 is made of a rigid material, such as wooden board, plastic, aluminum plate, or the like, so as to provide sufficient load-bearing capacity on the premise of keeping a light weight. When the seat apparatus is made of rigid materials, two ends of the seat apparatus 4 are respectively pivotally connected to two sides of a top portion of the front end of the folding cart body 1, such that the seat apparatus may be laid flat within the top portion of the front end of the folding cart body 1 during use, allowing the user to directly sit thereon when needed. The seat apparatus 4 is supported by the adapter rods 132 on the folding cart body 1 and is capable of supporting a weight of a person. The pivotal connection of the seat apparatus 4 allows a seat plate to be flipped counterclockwise at the front end of the folding cart body 1 when items are placed on the folding cart body 1, making the seat plate located outside the front end of the folding cart body 1 to avoid hindering the placement of items. After the items are placed, the seat plate may be directly flipped clockwise to make it located inside the front end of the folding cart body 1. Moreover, the rotatable configuration further prevents the folding cart body 1, when being folded and collapsed, from being unable to be fully folded due to the restriction imposed by the seat apparatus 4, thus eliminating the problem of excessive space occupation. In addition, the flip-over capability of the seat apparatus 4 facilitates its use as a dining table when used outdoors.

Further, in this embodiment, the seat apparatus 4 is made of a flexible material, the seat apparatus 4 is arranged on the top portion of the front end of the folding cart body 1, and a front side and/or a rear side of the seat apparatus 4 is provided with support rods connected to the folding cart body 1; and
specifically, in order to reduce an overall weight and improve seating comfort, the seat apparatus 4 may also be made of flexible materials, such as fabric. When the seat apparatus is made of fabric, two ends of the seat apparatus 4 are sleeved onto the adapter rods 132, and the seat apparatus 4 is supported by the adapter rods 132, allowing the user to sit directly on the seat apparatus 4. Due to the flexible nature of the seat apparatus 4, the seat apparatus 4 tends to sag under gravity during use, which may pull the bracket assemblies 13 on both sides toward a middle portion and cause tilting deformation, thereby affecting use. Therefore, support rods need to be arranged on the front side and/or the rear side of the seat apparatus 4, preferably on both the front side and the rear side. Both ends of each support rod need to be connected to the adapter rods 132 to prevent the bracket assemblies 13 on both sides from inclining toward a middle portion. It should be noted that the support rods may be detachably connected or slidably connected. A slidable connection means that the support rods are capable of sliding toward the steering rod assembly 2, so as to adjust positions of the support rods relative to the folding cart body 1 and prevent the support rods from interfering with the folding of the folding cart body 1 in the folding and collapsing process.

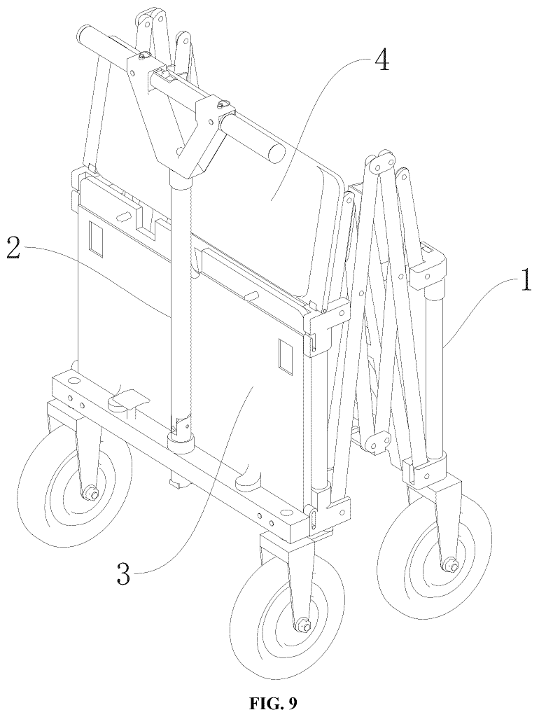

Use state and operating principle: As shown in FIG. 1, a driving state is illustrated. In this state, when folding is required, the footplate 3 is first lifted from the steering crossbar 21 and vertically positioned against a front end surface of the folding cart body 1; the steering rod assembly 2 is then pushed toward the folding cart body 1, causing the telescopic inner rods 18 to retract until the steering crossbar 21 is blocked by the folded-position limiting pin 33, the footplate 3 is subsequently pulled upward, allowing the telescopic inner rods 18 to completely retract, and the steering crossbar 21 is also completely retracted accordingly. At the same time, the fold-limiting sleeves 217 are pressed by the first rack 11 and retracted onto the extension blocks 219, rotational connection portions between the extension blocks 219 and the telescopic inner rods 18 are then exposed. When the steering crossbar 21 is completely retracted, the folded-position limiting pins 33 correspond to the pin holes 213. In this case, the footplate 3 is lowered, and the folded-position limiting pins 33 are inserted into the pin holes 213 to limit the movement of the steering crossbar 21. Subsequently, upward forces are applied at middle portions of the first rack 11 and the second rack 12, causing the first rack 11 and the second rack 12 to fold and collapse. During folding of the first rack 11 and the second rack 12, the bracket assemblies 13 on both sides are driven to fold together, until the folding is completed, as shown in FIG. 9.

When unfolding is required, a forward force is first applied to one end of the folding cart body 1, and a backward force is applied to the other end thereof, such that the first rack 11 and the second rack 12 are pulled apart from the folded state and flattened under the tension of the forward force and the backward force. When the first rack 11 and the second rack 12 are flattened, the bracket assemblies 13 on both sides are driven to synchronously unfold. After unfolding is completed, the footplate 3 is pulled upward to cause the folded-position limiting pins 33 to disengage from the pin holes 213. Subsequently, the steering rod assembly 2 is pulled forward to a predetermined distance, the footplate 3 is laid flat, at which time the unfolded-position limiting pins 34 are inserted into the pin holes 213, thereby limiting the movement of the steering rod assembly 2 in the unfolded state and preventing the steering rod assembly from retracting or extending. In addition, when the steering rod assembly 2 is extended, the fold-limiting sleeves 217 are no longer pressed by the first rack 11, and the fold-limiting sleeves 217 are pushed outward by restoring forces of the sleeve return springs and positioned at connection portions between the extension blocks 219 and the telescopic inner rods 18, thereby limiting rotation of the steering crossbar 21 relative to the telescopic inner rods 18, and completing the unfolding accordingly, in which case, the user may sit on the seat apparatus 4, place feet on the footplate 3, and operate the steering rod assembly 2 with hands for control.

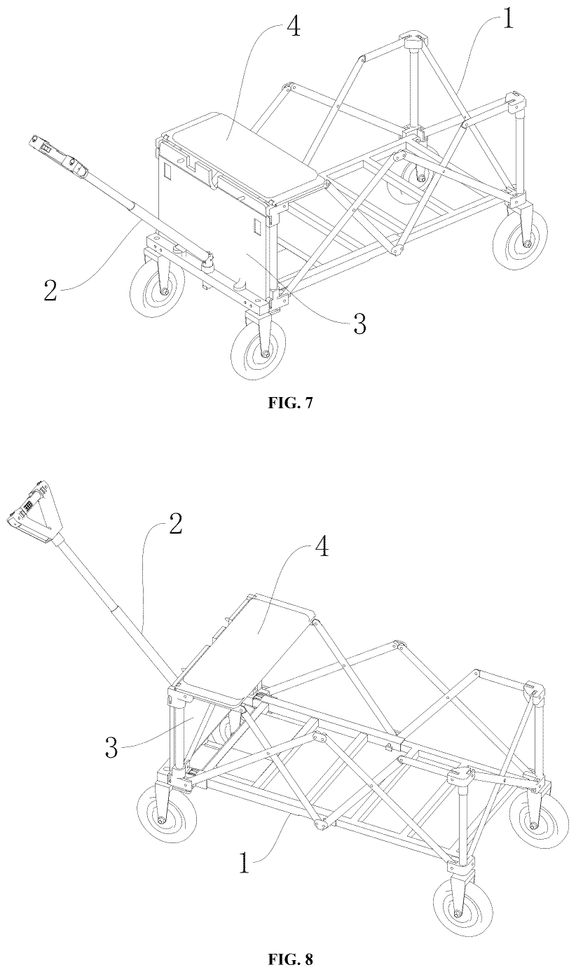

In a semi-unfolded state, as shown in FIGS. 7 and 8, the folding cart body 1 is in a fully unfolded state, while the steering rod assembly 2 is in an unextended state, which is conducive to towing. In this state, the limiting-pin button 229 may be pressed to cause the limiting pin 228 to be retracted, and the steering rod 22 is then pulled to extend relative to the sleeve rod. When the steering rod 22 is extended by a predetermined distance, and the steering rod 22 is aligned with the limiting hole 227, the limiting pin 228 automatically extends into the limiting hole 227 to limit the movement of the steering rod 22 again. In addition, when the steering rod 22 is extended, the fold-limiting member 232 is no longer pressed by the steering rod 22 and is pushed upward by a restoring force of the fold-limiting return spring 233, causing an end of the fold-limiting member 232 to disengage from the insertion hole 215 and retract into the protruding block 231, in which case, the sleeve rod 23 can rotate upward or downward relative to the pivot rod 211, causing the steering rod 22 to be in an inclined position, thereby facilitating towing. Of course, a towing posture of the steering rod assembly 2 may also be switched when the electric cart is in a driving state, and driving is also possible in the semi-unfolded state. However, since a distance between a support point of the first wheel 24 and a support stress port point of the seat apparatus 4 is too short, forward tipping is likely to occur when gravity shifts forward, resulting in rear-end lifting and safety risks. Therefore, driving by the user seated in this state is not recommended.

In summary, in this present disclosure, the seat apparatus 4 is arranged on the top portion of the front end of the folding cart body 1, so as to implement a seating function and to enable use of the electric cart to be more labor-saving. In addition, the steering rod assembly 2 is slidably connected to the folding cart body 1, so that the steering rod assembly 2 can extend out, to increase the distance between a support stress point of the seat apparatus 4 and a support point of the first wheel 24, so that the stability of manned driving is improved and safety performance is improved. Moreover, the front end of the folding cart body 1 is provided with a footplate 3, to facilitate foot placement and standing driving, so that the electric cart can be used in more diverse situations. Moreover, the electric cart can be folded for storage, thereby providing enhanced convenience.

The present disclosure is not only limited to the descriptions in the specification and implementations, such that those skilled in the art may easily achieve additional advantages and modifications. Therefore, the present disclosure is not limited to specific details, representative apparatus and illustrative examples shown and described herein without departing from the spirit and scope of the general concept as defined by the appended claims and equivalents thereof.

What is claimed is:

1. A novel manned folding electric cart, comprising: a folding cart body, wherein the folding cart body is folded and collapsed in a front-to-rear direction; a seat apparatus is arranged on a top portion of a front end of the folding cart body; a steering rod assembly is connected to a bottom portion of the front end of the folding cart body, at least one first wheel is connected to the steering rod assembly; an end of the folding cart body away from the steering rod assembly is provided with at least two second wheels, and the folding cart body is further provided with a power supply for providing power to the first wheel and/or the second wheels, and a controller for controlling the operation of the first wheel and/or the second wheels; the folding cart body comprises a first rack and a second rack; one end of the first rack is connected to one end of the second rack, and each of two sides of the first rack is provided with a bracket assembly, and two ends of the bracket assembly on each side are respectively connected to support assemblies; and
when the first rack and the second rack are folded and collapsed, the support assemblies at two sides are driven to fold simultaneously.

2. The novel manned folding electric cart according to claim 1, wherein telescopic inner rods are respectively slidably arranged at two sides of one end inside the first rack, and the telescopic inner rods are extendable out of the first rack to drive the steering rod assembly away from the first rack.

3. The novel manned folding electric cart according to claim 1, wherein the steering rod assembly comprises a steering crossbar, and a steering rod; and the first wheel is arranged below the steering crossbar, a pivot rod is inserted through a middle portion of the steering crossbar, and the pivot rod is rotatable relative to the steering crossbar in a horizontal direction, and a bottom portion of the pivot rod is connected to the first wheel, and the steering rod drives the first wheel to steer through the pivot rod.

4. The novel manned folding electric cart according to claim 3, wherein the steering rod assembly further comprises a sleeve rod; one end of the sleeve rod is pivotally connected to a top portion of the pivot rod; and the steering rod is slidably disposed inside the sleeve rod, and the steering crossbar is pivotally connected to the telescopic inner rods.

5. The novel manned folding electric cart according to claim 2, wherein a support frame is connected between two support assemblies at the same ends of two bracket assemblies; and horizontal adapter rods are respectively connected to top portions of two ends of the bracket assembly on each side, and the top portions of two ends of the bracket assembly are connected to the support assemblies through the adapter rods.

6. The novel manned folding electric cart according to claim 3, wherein two first wheels are provided; and the two first wheels are respectively arranged at two ends of the steering crossbar, an end of the pivot rod away from the steering rod is movably connected to a steering connecting rod, and two ends of the steering connecting rod are respectively pivotally connected to the two first wheels.

7. The novel manned folding electric cart according to claim 3, wherein bottom ends of the two support assemblies adjacent to the steering rod assembly are respectively provided with vertical first sliding slots; and a footplate is disposed between the two first sliding slots, two sides of a bottom end of the footplate are respectively provided with first sliding pins, and the bottom end of the footplate is slidably connected to the first sliding slots through the first sliding pins.

8. The novel manned folding electric cart according to claim 7, wherein a bottom end of a bottom surface of the footplate is provided with at least one folded-position limiting pin for restricting translational movement of the steering rod assembly when the footplate is in a folded state, at least one pin hole adapted to the folded-position limiting pin is formed in a top surface of the steering crossbar, and a relief hole adapted to the pivot rod is further formed in a middle portion of a top end of the footplate.

9. The novel manned folding electric cart according to claim 8, wherein a top end of the bottom surface of the footplate is provided with at least one unfolded-position limiting pin for restricting translational movement of the steering rod assembly when the footplate is in an unfolded state, and the unfolded-position limiting pin is adapted to the pin hole.

10. The novel manned folding electric cart according to claim 4, wherein spaced pivot connecting lugs are arranged at the top portion of the pivot rod, and an insertion hole is formed between the two pivot connecting lugs; a protruding block is arranged at a bottom end of the sleeve rod, the protruding block is inserted between the two pivot connecting lugs and is pivotally connected via a pivot shaft; and a folding-limiting member is movably disposed inside the bottom end of the sleeve rod; and when the steering rod presses against the folding-limiting member, one end of the folding-limiting member protrudes from the protruding block and is inserted into the insertion hole to limit the movement of the sleeve rod relative to the pivot rod.

11. The novel manned folding electric cart according to claim 4, wherein a handle ring is disposed at a top portion of the steering rod; two folding grooves are respectively formed on two sides of the handle ring, grip rods are pivotally connected to same ends of the two folding grooves, one of the grip rods is electrically connected to the controller for controlling operating speed of the first wheel and/or the second wheels.

12. The novel manned folding electric cart according to claim 11, wherein corresponding limiting holes are respectively formed in a side wall of the steering rod and a side wall of the sleeve rod, limiting pins are further disposed inside the steering rod, and the limiting pins are adapted to the limiting holes; and a limiting-pin button is disposed inside a bottom end of the handle ring, and the limiting-pin button is configured to drive the limiting pins to extend and retract.

13. The novel manned folding electric cart according to claim 3, wherein a braking device is further disposed on the steering crossbar, and the braking device is connected to the first wheels.

14. The novel manned folding electric cart according to claim 3, wherein a folding-limiting sleeve is sleeved at a pivotal connection position between each telescopic inner rod and the steering crossbar, a sleeve return spring is disposed at an end of the folding-limiting sleeve facing the steering crossbar, and the folding-limiting sleeve is located at the connection position between the telescopic inner rod and the steering crossbar under the force of the sleeve return spring.

15. The novel manned folding electric cart according to claim 1, wherein the seat apparatus is made of a rigid material, both ends of the seat apparatus are respectively pivotally connected to two sides of the top portion of the front end of the folding cart body, and the seat apparatus is flipped forward or backward relative to the folding cart body.

16. The novel manned folding electric cart according to claim 1, wherein the seat apparatus is made of a flexible material, the seat apparatus is arranged on the top portion of the front end of the folding cart body, and a front side and/or a rear side of the seat apparatus is provided with support rods connected to the folding cart body.

17. The novel manned folding electric cart according to claim 2, wherein ends of the telescopic inner rods away from the second rack are pivotally connected to the steering rod assembly.
